(19) United States
(12) Patent Application Publication
(10) Pub. No.: US 2025/0111669 A1
(43) Pub. Date: Apr. 3, 2025

(54) FORESTRY MANAGEMENT SYSTEM AND METHOD

(71) Applicant: Purdue Research Foundation, West Lafayette, IN (US)

(72) Inventors: Joshua Carpenter, Lafayette, IN (US); Songlin Fei, West Lafayette, IN (US); Jinha Jung, West Lafayette, IN (US)

(21) Appl. No.: 18/834,474

(22) PCT Filed: Jan. 30, 2023
(86) PCT No.: PCT/US2023/011898

§ 371 Date: Jul. 30, 2024

Related U.S. Application Data
(60) Provisional application No. 63/304,838, filed on Jan. 31, 2022.

(51) Int. Cl. G06V 20/10; G06T 7/00; G06T 7/162; G06T 7/70; G06V 10/762

(52) U.S. Cl. CPC G06V 20/188; G06T 7/0012; G06T 7/162; G06T 7/70; G06V 10/7635; G06T 2207/10028; G06T 2207/10032; G06T 2207/20072; G06T 2207/30188

(57) ABSTRACT

The forestry management system 100 includes a processor 102 which executes steps to input point cloud data into the forestry management system 100, segment an individual tree from the point cloud data using unsupervised, graph-based clustering, identify a metric of a tree using an algorithm, and determine a trunk location of the tree. The metrics include a height of the tree, a biomass of the tree, a health status of the tree, and/or a species of the tree. The metric also includes a stem location and/or a position of the tree. The algorithm has a canopy-to-root routing direction.

### FIELD

The disclosure generally relates to forest management systems and, more particularly, to point cloud data management systems.

### INTRODUCTION

This section provides background information related to the present disclosure which is not necessarily prior art.

Private landowners, private forest industries, non-governmental agencies, federal agencies, and state agencies have an interest in managing the quantity, the health, and the size of each tree within a selected forest. Properly identifying individual trees is a critical part in the management of forests. Known methods of identifying the quantity, the health, and the size of the trees making up the forest include manual field samplings. Manual field samplings include measuring a portion of the forest and attributing the results of that portion to represent the forest as a whole.

Manual field samplings may provide a representation of the forest, but this representation may provide certain inaccuracies that would provide a false representation of the forest. Such inaccuracies may include over-estimations and/or under-estimations of the height, the diameter, the species, and the health of the trees. More accurate methods of analysis are necessary to ensure proper monitoring of the forests. Additionally, manual field sampling only allows for individual tree monitoring for trees within the sample area. To monitor all individual trees within a forest requires automation.

Manual field samplings are also an inefficient process to analyze a forest. For instance, it is time consuming for a user to portion off a section of the forest. Further, the user must individually analyze each tree within that section. Once the section of the forest is analyzed, the user must perform calculations to identify how the forest as a whole is represented by the analyzed sample.

Known methods of land management include the use of aerial imaging and LIDAR technology. These known methods are configured to monitor property lines and equipment locations. However, these known methods of land management are not configured to analyze the height, the diameter, the location, the species, and the health of individual trees within a forest.

For several decades, aerial imagery has been the foundation for attempts to automatically perform forest inventories. Image-based stem mapping methods generally maximize any spectral difference between the canopy nearest the trunk and the canopy further from the trunk. These algorithms can be roughly grouped into three methods: local maxima search, valley following, and region growing.

Local maxima search locates stems by labeling clusters of local maximum points as trunk locations. For instance, a method where a moving window was passed over single-band imagery, and the local brightest pixels were marked. The assumption behind this method is that tree canopies are generally conical or spherically shaped and will thus catch more sunlight at the peak of the tree than near the edges or base. When seen from above, trees will appear as circles with bright centers. Subsequent work in this category researched the utility of alternating the size of the moving window.

Valley following is another approach for finding the position of individual trees. This method uses an analogous assumption to the local maxima method. Instead of finding local brightest peaks, the valley following method attempts to trace the shaded valleys between peaks of coniferous trees.

With the improvement of image segmentation algorithms, region-growing algorithms, such as watershed segmentation, were applied to tree detection. In some instances, the local maxima point was used as a seed point, and then applied region growing to segment the shaded edges of the canopy. Watershed segmentation has been applied to images to refine tree crowns, limiting the extent of the watershed region by the geodesic distance from the estimated trunk location.

These image-based methods suffer from several limitations. The nature of image data limited these methods to detecting basic tree parameters, such as stem location and crown delineation, of only trees tall enough to breach the upper canopy. Additionally, because the fundamental premise of these methods is that bright spots represent canopy peaks, tree spacing must be ideal. If trees are spaced too closely, no distinction can be made between individuals. If trees are spaced too far apart, grassy areas between trees can have crown-like brightness values and cause false positives. Further, the quality of the stem mapping results depends on the resolution of the input data.

As airborne LiDAR and other airborne ranging technologies were commercialized, the image methods discussed above began to be applied to Digital Surface Models (DSMs). Segmentation on DSMs provides better results since the values in the image represent the elevation of the top of the canopy and are no longer dependent on reflected sunlight. Watershed algorithms were utilized to map canopy extent, and certain applications utilized the local maxima method by applying circular moving window filters of various sizes.

While the DSM-based methods provide better results than the image-based approach previously described, two critical problems plague all raster-based methods thus far discussed. First, neither imagery nor DSMs detect any features below the canopy-features necessary to measure when performing forest inventories. Second, both raster-based methods assume that the center of the tree will correspond to a local maximum point in the canopy. This assumption about the shape of the canopy is often valid for coniferous trees, leading most methods discussed above to be solely tested on coniferous forests where the conical shape and wide spacing of the variety make segmentation easier. However, studies that perform stem mapping over deciduous forests find a significant reduction in accuracy since deciduous canopies have minor height differences between the center and edges and tend to intertwine with neighboring trees.

With the proliferation of laser raging technology in the form of terrestrial laser scanners and airborne, manned and unmanned systems, LiDAR has become the default choice for forest inventory automation research. The advantage of LiDAR over aerial imagery is its ability to capture features in three dimensions, giving users the potential to measure the full range of tree features necessary to replicate forest inventories, a feat unattainable from imagery alone.

Though terrestrial laser scanners (TLS) cannot cover large areas quickly, a significant advantage of the technology over its airborne cousin is the level of detail that can be captured. TLS forest point clouds have the potential to capture detail as minute as the texture of tree bark. However, a prerequisite to extracting tree features from point clouds is segmenting the point cloud data into individual trees. Segmentation is a challenging task. The complex geometry of trees, the diversity of tree structure, and the entangled nature of the forest environment, especially in natural forests, make it difficult to procedurally segment individual trees from point clouds.

Many methods have been proposed to segment individual trees from this high-resolution data. These methods will be introduced in the following categories: deep learning, point density, building block, and graph-based methods.

Detecting objects in point clouds using deep learning methods is a growing area of research. Though most research has been aimed at recognizing manmade objects, these methods have also been used for tree stem mapping and point cloud segmentation. This approach has yielded promising results on small point cloud datasets of relatively uniform trees; however, the lack of large amounts of labeled data has been cited as a major limitation to expanding this approach. An additional barrier to implementing these methods on larger data sets is the computational power needed to train and implement the models. Current methods are limited in the area that can be processed.

Point density methods attempt to segment individual trees by first finding tree trunks based on the hypothesis that areas of high point density and elevation correspond to trunk locations, and then segmenting the remaining points in the point cloud based on their relationship to the found trunk locations. A common procedure is to create a grid of two-dimensional cells in the cartesian plane (i.e., X, Y coordinates) and populate each cell with the sum of all point elevations falling within it. Local maxima points are then extracted from the resulting raster. These peaks are labeled as tree trunk locations. The remaining points can then be attached to each trunk location through various methods. The most common method is to simply label each point within a given radius to the nearest trunk. This point density method works well where trees are of similar size and planted in equally spaced rows as found on plantations. Here, known tree spacing can be added as prior information to improve row and tree detection. This method yields poor results where trees of mixed height and size exist in the same scene. Smaller trees often have fewer points on their trunks than larger trees, making results highly dependent on the values chosen for the grid size and the thresholds used for peak detection.

Building block methods also follow a two-step process for tree extraction. First, probable trunks are detected as single points or clusters of points, and then a second step attempts to “grow” a tree from each trunk by iteratively selecting adjacent chunks of the point cloud and adding these chunks to the growing tree based on some criteria. Early forms of the building block method were developed for converting single-tree point clouds into a representative set of geometric shapes. For instance, single-tree point clouds may be divided into small chunks and then, after picking a starting chunk, use these chunks to build cylindrical and linear branching features iteratively. Several methods for detecting the starting point or trunk exist, such as detecting vertical cylinders in the understory, finding vertical features by identifying clusters of points present in multiple elevation layers of the point cloud, and identifying clusters of points in the understory after a vegetation filtering routine. After detecting the starting point, or starting trunk, for each tree, the remaining points are added, usually iteratively, to the appropriate starting trunk. One method is to cluster the remaining points through voxelization and then to use connected component analysis to grow each tree from the starting. Points can also be segmented directly by iteratively attaching each point to the trunk belonging to the nearest previously attached point. With this method, better segmentation accuracy can be obtained by density-based spatial clustering where trees overlap.

Graph-based methods for segmenting the branching structure of trees from 3D point clouds assume that any given part of a tree must be connected by some path through the structure of the tree to the trunk and root system. Some of the first uses of graphs for modeling trees from remotely sensed data were introduced to create more realistic trees for virtual worlds. Graphs were further adopted in certain circumstances as a method for applying wood/leaf classification to single-tree point clouds. First, the point cloud of a tree is converted into a network of nodes and edges. Then, under the assumption that a tree is a structure that connects each leaf to the root through woody branches, the least-cost path from each node down to the root of the tree is calculated, allowing each node to be ranked based on the number of paths passing through it. High-use nodes are labeled as branches, while nodes used by few paths are labeled as vegetation.

Classifying woody and leafy structures from the point cloud has continued to be the major impetus for further development of graph-based classification algorithms; however, using graphs to segment individual trees has received some secondary attention. These approaches tend to work from the ground upward, starting with trunk locations found through initial processing and then growing the tree in a root-to-canopy direction using least-cost pathing. Known methods include a two-step, graph-based tree segmentation algorithm that utilizes the results of wood/leaf classification to identify individual trunks within a forest point cloud and then segment trees by connecting branches and leafy structures to the nearest trunk by graph distance. Another known method includes a graph-based method for isolating individual trees from multi-tree scans of orchards. Both known methods require a two-step process beginning with a trunk finding procedure followed by a least-cost pathing routine to segment trees.

Accordingly, there is a continuing need for an improvement on the data interpretation methods outlined above and for a forestry management system to process, store, and facilitate interactions with high-resolution forest data to achieve more efficient and effective forest analysis and management. Desirably, the forestry management system may also analyze individual trees within the forest for the height, the diameter, the location, the species, and health.

### SUMMARY

In concordance with the instant disclosure, a forestry management system that more efficiently and effectively analyzes a forest, has surprisingly been discovered. Desirably, the forestry management system also analyzes individual trees within the forest.

The forestry management system is configured to identify certain characteristics of a tree using a processor. The processor executes steps to input point cloud data into the forestry management system, segment individual trees from the point cloud data using unsupervised, graph-based clustering, identify a range of tree metrics using an algorithm, and determine trunk locations of the trees. The tree metrics may include at least a height of the tree, a biomass of the tree, a health status of the tree, and/or a species of the tree. In a specific example, the metric may include a stem location and/or a position of the tree. The position of the tree may be the angle of a trunk of the tree in relation to a ground surface. For instance, the processor may determine if the tree is upright or if the tree has fallen based on the position of the tree. The algorithm may have a canopy-to-root routing direction. In a specific example, the canopy-to-root routing direction may simultaneously segment the point cloud data and discover a stem location of the tree.

Various ways of using the forestry management system are provided. For instance, a method may include a step of providing the forestry management system. The forestry management system may include a processor. The processor may execute steps to input point cloud data into the forestry management system, identify a metric of a tree using an algorithm having a digital terrain model, and segment the tree from the point cloud data using unsupervised, graph-based clustering. The method may include a step of inputting point cloud data onto the forestry management system. Next, the processor may preprocess the point cloud data. Preprocessing the point cloud data may include normalizing the point cloud data by subtracting a terrain elevation from each point in the point cloud data. In a specific example, the step of preprocessing the point cloud data may include identifying a plurality of voxel cells and aggregating each point within the corresponding voxel cells, thus forming a superpoint from each aggregation. In a more specific example, the step of preprocessing the point cloud data may also include applying a point count threshold by ignoring voxels containing fewer than a predetermined number of points. One skilled in the art may select any number of points to determine a point count threshold. For instance, the point count threshold may be around ten points per voxel. Then, the method may include a step of building a graph model. In a specific example, the graph model may be built by defining an edge between at least two superpoints. More specifically, each superpoint may be also defined as a node. The edge may be defined by connecting two or more nodes. Afterwards, a ground point and a canopy point may be identified by the processor. Next, at least one cost value of the edge to the ground point may be determined. Then, a least-cost route of the canopy to root path may be identified. The tree may then be segmented from the remaining point cloud data. Next, the trunk location of the tree may be determined.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a schematic drawing of a forestry management system, according to one embodiment of the present disclosure;

FIG. 2 is a schematic diagram of the system, further depicting the system having a communication interface, an input interface, a user interface, and a system circuitry, wherein the system circuitry may include a processor and a memory, according to one embodiment of the present disclosure;

FIG. 3 a flow diagram of the components of the forestry management system, further depicting the direction of communication between the components, according to one embodiment of the present disclosure;

FIG. 4 is a point diagram illustrating raw input point cloud, according to one embodiment of the present disclosure;

FIG. 5 is the point diagram, as shown in FIG. 4, illustrating the point cloud data after normalization, according to one embodiment of the present disclosure;

FIG. 6 is the point diagram, as shown in FIGS. 4-5, illustrating the visualization of voxel divisions for superpoint encoding, according to one embodiment of the present disclosure;

FIG. 7 is the point diagram, as shown in FIGS. 4-6, illustrating the point cloud data after superpoint encoding, according to one embodiment of the present disclosure;

FIG. 8 is the point diagram, as shown in FIGS. 4-7, illustrating the rough classification, further depicting upper superpoints as ‘canopy’ superpoints, lower superpoints as ‘ground’ superpoints, and the middle superpoints as ‘unlabeled’ superpoints, according to one embodiment of the present disclosure;

FIG. 9 is the point diagram, as shown in FIGS. 4-8, illustrating the superpoints with a connectivity graph, according to one embodiment of the present disclosure;

FIG. 10 is the point diagram, as shown in FIGS. 4-9, illustrating the tree sets built by least-cost routing, according to one embodiment of the present disclosure;

FIG. 11 is the point diagram, as shown in FIGS. 4-10, illustrating the trees formed by grouping tree sets, according to one embodiment of the present disclosure;

FIG. 12 is the point diagram, as shown in FIGS. 4-11, illustrating the mapping of the tree labels back to the original point cloud points, according to one embodiment of the present disclosure;

FIG. 13 is the bar graph, illustrating the comparison of the number of omissions by tree height superimposed on the number of trees in the validation data of the same height class for all of the TLS Datasets analyzed, according to one embodiment of the present disclosure;

FIG. 14 is the bar graph, illustrating the comparison of the omission errors as a percentage of total trees within each height class for all of the TLS datasets analyzed, according to one embodiment of the present disclosure;

FIG. 15 is the bar graph, illustrating the comparison of the number of omissions by tree height superimposed on the number of trees in the validation data of the same height class for the Photo-Plantation dataset analyzed, according to one embodiment of the present disclosure;

FIG. 16 is the bar graph, illustrating the comparison of the omission errors as a percentage of total trees within each height class for the Photo-Plantation dataset analyzed, according to one embodiment of the present disclosure;

FIG. 17 is the bar graph, illustrating the comparison of the number of omissions by tree height superimposed on the number of trees in the validation data of the same height class for the Photo-Natural dataset analyzed, according to one embodiment of the present disclosure;

FIG. 18 is the bar graph, illustrating the comparison of the omission errors as a percentage of total trees within each height class for the Photo-Natural dataset analyzed, according to one embodiment of the present disclosure;

FIG. 19 is the bar graph, illustrating the comparison of the number of omissions by tree height superimposed on the number of trees in the validation data of the same height class for the LiDAR-Natural dataset analyzed, according to one embodiment of the present disclosure;

FIG. 20 is the bar graph, illustrating the comparison of the omission errors as a percentage of total trees within each height class for the LiDAR-Natural dataset analyzed, according to one embodiment of the present disclosure;

FIG. 21 is a segmented point diagram illustrating a prior art example of ‘split tree’ error where one tree is split into two because branches provide paths to the ground which do not route through the trunk;

FIG. 22 is a segmented point diagram illustrating a prior art example of ‘greedy tree’ error where a taller tree is segmented incorrectly because the shorter tree provides a route to the ground for the taller tree's left side that does not pass through the taller tree's trunk;

FIG. 23 is a segmented point diagram illustrating a prior art example of ‘detached tree’ error where two trees are segmented as a single tree because the point cloud did not capture the trunk of the tree on the right;

FIG. 24 is a bar graph illustrating a comparison of benchmark count versus omission count in relation to tree height in the International TLS1—Easy Benchmark dataset, according to one embodiment of the present disclosure;

FIG. 25 is a bar graph illustrating the omission rate by tree height in the International TLS1—Easy Benchmark dataset, according to one embodiment of the present disclosure;

FIG. 26 is a bar graph illustrating a comparison of benchmark count versus omission count in relation to tree height in the International TLS2—Easy Benchmark dataset, according to one embodiment of the present disclosure;

FIG. 27 is a bar graph illustrating the omission rate by tree height in the International TLS2—Easy Benchmark dataset, according to one embodiment of the present disclosure;

FIG. 28 is a bar graph illustrating a comparison of benchmark count versus omission count in relation to tree height in the International TLS3—Intermediate Benchmark dataset, according to one embodiment of the present disclosure;

FIG. 29 is a bar graph illustrating the omission rate by tree height in the International TLS3-Intermediate Benchmark dataset, according to one embodiment of the present disclosure;

FIG. 30 is a bar graph illustrating a comparison of benchmark count versus omission count in relation to tree height in the International TLS4—Intermediate Benchmark dataset, according to one embodiment of the present disclosure;

FIG. 31 is a bar graph illustrating the omission rate by tree height in the International TLS4—Intermediate Benchmark dataset, according to one embodiment of the present disclosure;

FIG. 32 is a bar graph illustrating a comparison of benchmark count versus omission count in relation to tree height in the International TLS5—Difficult Benchmark dataset, according to one embodiment of the present disclosure;

FIG. 33 is a bar graph illustrating the omission rate by tree height in the International TLS5—Difficult Benchmark dataset, according to one embodiment of the present disclosure;

FIG. 34 is a bar graph illustrating a comparison of benchmark count versus omission count in relation to tree height in the International TLS6—Difficult Benchmark dataset, according to one embodiment of the present disclosure;

FIG. 35 is a bar graph illustrating the omission rate by tree height in the International TLS6—Difficult Benchmark dataset, according to one embodiment of the present disclosure; and

FIG. 36 is a flowchart depicting a method for using the forestry management system, according to one embodiment of the present disclosure.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping, or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the FIG. is turned over, elements described as “below”, or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

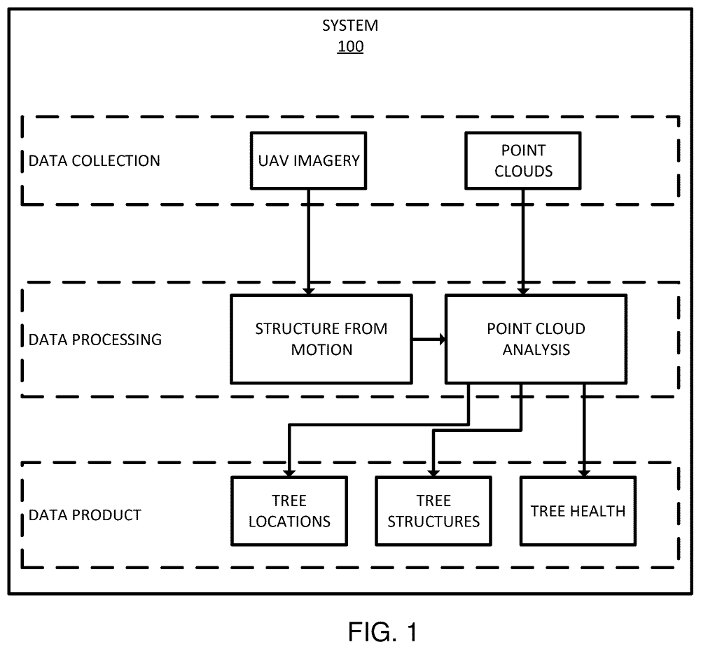

As shown in FIG. 1, a forestry management system 100 that is configured to identify certain characteristics of a tree includes a processor 102. The processor 102 executes steps to input point cloud data into the forestry management system 100, segment an individual tree from the point cloud data using unsupervised, graph-based clustering, identify a metric of a tree using an algorithm, and determine a trunk location of the tree. The metric of the tree may be understood as a measurement of a characteristic of the tree based on the point cloud data. With continued reference to FIG. 1, the metrics may include a height of the tree, a biomass of the tree, a health status of the tree, and/or a species of the tree. In a specific example, the metric may include a stem location and/or a position of the tree. The position of the tree may be the angle of a trunk of the tree in relation to a ground surface. For instance, the processor 102 may determine if the tree is upright or if the tree has fallen based on the position of the tree. The algorithm may include a digital terrain model. The algorithm may have a canopy-to-root routing direction. In a specific example, the canopy-to-root routing direction may simultaneously segment the point cloud data and discover a stem location of the tree.

In certain circumstances, metrics of the tree or a selected grouping of trees may include various fields. For instance, the size of the tree may include a height of the tree, a diameter of the tree, a center of the tree, a location of a branch on the tree, a diameter of the branch, a branch structure of the tree, and a canopy diameter of the branches of the tree. In a specific example, the diameter of the tree may be recorded at breast height. In other words, the diameter of tree may be measured at around four to five feet above a ground surface of the tree. The metric may further include a shape of the tree and/or a shape of the branch of the tree. For instance, the metric may indicate whether the tree and/or the branch is substantially straight or curvy.

In certain circumstances, the point cloud data may include a variety of forms and may be obtained through various ways. For instance, the point cloud data may include aerial images and laser scans. In a more specific example, the aerial images may include unmanned aerial vehicle images taken as two-dimensional images. In another specific example, the laser scans may include terrestrial laser scanning, aerial lidar, and mobile lidar on automotive vehicles. In a specific example, the processor 102 may execute steps to output three-dimensional point cloud data from the two-dimensional images and laser scans. In a particular embodiment, the three-dimensional point cloud data may be collected during different seasons of the year and the forestry management system 100 may be configured to analyze the health and the growth of the forest over time. More particularly, the forestry management system 100 may be designed for the user to upload point cloud data of the same area of interest for multiple times a year, over many years to enhance the observance of the growth and the health of the forest. In a more specific example, the processor 102 may be configured to analyze uploaded point cloud data in comparison to historical point cloud data. In an even more specific example, the processor 102 may output statistics comparing the uploaded point cloud data to the historical point cloud data.

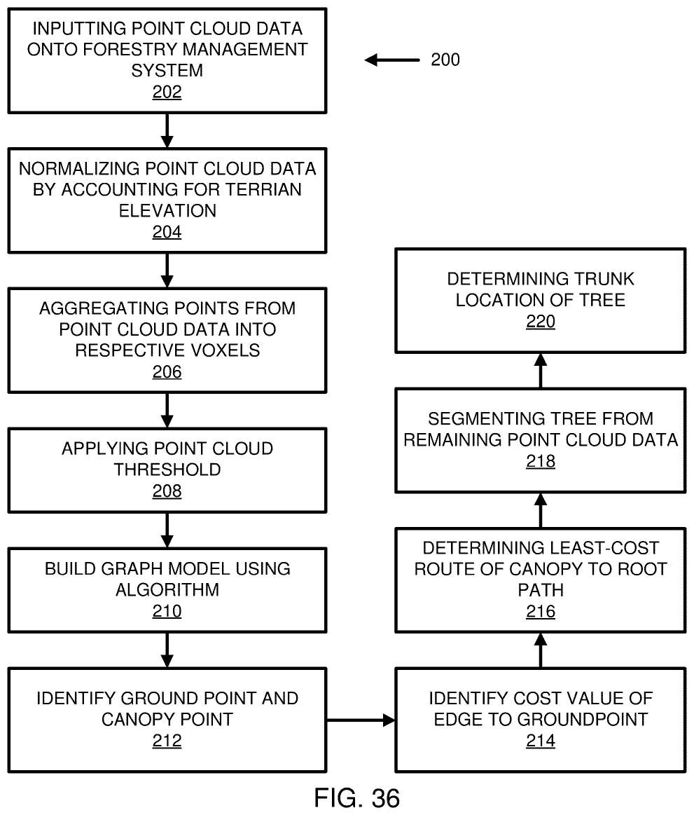

Various ways of using the forestry management system 100 are provided. For instance, as shown in FIG. 36, a method 200 may include a step 202 of inputting point cloud data onto the forestry management system 100. Next, the processor 102 may preprocess the point cloud data. Preprocessing the point cloud data may include a step 204 of normalizing the point cloud data by subtracting a terrain elevation from each point in the point cloud data. In a specific example, preprocessing the point cloud data may include a step 206 of identifying a plurality of voxel cells and aggregating each point within the corresponding voxel cells, thus forming a superpoint from each aggregation. In a more specific example, preprocessing the point cloud data may also include a step 208 of applying a point count threshold by ignoring voxels containing fewer than a predetermined number of points. One skilled in the art may select any number of points to determine a point count threshold. For instance, the point count threshold may be around ten points per voxel. Then, the method may include a step 210 of building a graph model. In a specific example, the graph model may be built by defining an edge between at least two superpoints. More specifically, each superpoint may be also defined as a node. The edge may be defined by connecting two or more nodes. In a specific example, the graph model may be calculated from the algorithm as:

N=(P,E,W)

In certain circumstances, the algorithm may include various variables. For instance, Table 1 defines certain symbols utilized in the algorithm. Additionally, Table 1 includes non-limiting examples of the values used for the corresponding symbol.

TABLE 1
A list of the user-defined parameters used in the proposed algorithm

| Symbol | Description | Non-Limiting Examples |
|---|---|---|
| s | Size of the voxel cube used to compute | 0.3 meters |
| | super points | |
| b | A voxel must contain more than b points to | 10-TLS and Photo Datasets |
| | be used to create a super point | 2-LiDAR Dataset |
| gₘₐₓ | A threshold value determining the highest | 1.2 meters |
| | elevation for a ‘ground’ classified superpoint | |
| cₘᵢₙ | A threshold value detennining the lowest | 2 meters |
| | elevation for a ‘canopy’ superpoint | |
| k | The number of nearest neighbors connected | 10 |
| | to each superpoint in the initial graph | |
| | construction | |
| d | The merge distance within which two tree | 3 s = 0.9 meters |
| | sets will be merged to form a single tree | |

Afterwards, a canopy to root path of the tree may be identified by the processor 102. Identifying the canopy to root path may include identifying a ground point and a canopy point based on a height of the superpoints. In a specific example, the ground point and the canopy point may be calculated from the algorithm as:

$${p}_{i} ∈ \{ \begin{matrix}G & if {h}_{i} \leq {g}_{max} \\ C & if {h}_{i} \geq {c}_{min}\end{matrix}$$

In certain circumstances, identifying the canopy to root path of the tree may further include a step 214 of identifying a cost value of the edge to the ground point. The cost value may further be used to identify a least-cost route of superpoints between the canopy point and the ground point. In a specific example, the cost value may be calculated from the algorithm as:

$$W ( {e}_{ij} ) = {‖ {p}_{i} - {p}_{j} ‖}^{2}$$

Then, the tree may be segmented from remaining point cloud data in another step 218. Next, the method 200 may include a step 220 of determining a trunk location of the tree. In a specific example, identifying the canopy to root path of the tree and segmenting the tree from remaining point cloud data may occur simultaneously. Alternatively, the step 218 of segmenting the tree from remaining point cloud data may precede the step 220 of determining a trunk location of the tree.

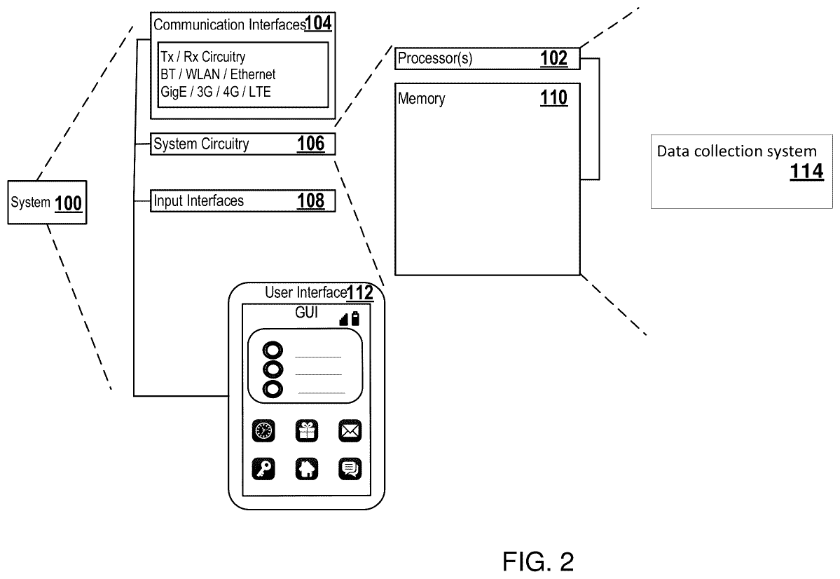

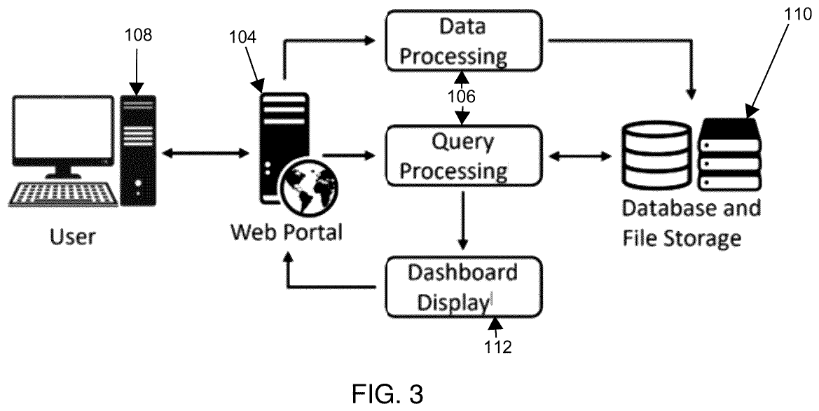

As shown in FIGS. 2-3, forestry management system 100 may further include a communication interface 104, a system circuitry 106, and/or an input interface 108. The system circuitry 106 may include the processor 102 or multiple processors. The processor 102 or multiple processors execute the steps to input point cloud data, extract an individual tree and/or a desired grouping of specific trees from the point cloud data using unsupervised, graph-based clustering, and categorize certain metrics of the tree and/or grouping of trees. Alternatively, or in addition, the system circuitry 106 may include memory 110.

The processor 102 may be in communication with the memory 110. In some examples, the processor 102 may also be in communication with additional elements, such as the communication interfaces 104, the input interfaces 108, and/or the user interface 112. Examples of the processor 102 may include a general processor, a central processing unit, logical CPUs/arrays, a microcontroller, a server, an application specific integrated circuit (ASIC), a digital signal processor, a field programmable gate array (FPGA), and/or a digital circuit, analog circuit, or some combination thereof.

The processor 102 may be one or more devices operable to execute logic. The logic may include computer executable instructions or computer code stored in the memory 110 or in other memory that when executed by the processor 102, cause the processor 102 to perform the operations of a data collection system, such as a UAV-based photogrammetry, terrestrial laser scanning, and/or aerial LiDAR platform. The computer code may include instructions executable with the processor 102.

The memory 110 may be any device for storing and retrieving data or any combination thereof. The memory 110 may include non-volatile and/or volatile memory, such as a random-access memory (RAM), a read-only memory (ROM), an erasable programmable read-only memory (EPROM), or flash memory. Alternatively or in addition, the memory 110 may include an optical, magnetic (hard-drive), solid-state drive or any other form of data storage device. The memory 110 may be included in any component or sub-component of the system 100 described herein.

The user interface 112 may include any interface for displaying graphical information. The system circuitry 106 and/or the communications interface(s) 112 may communicate signals or commands to the user interface 112 that cause the user interface to display graphical information. Alternatively or in addition, the user interface 112 may be remote to the system 100 and the system circuitry 106 and/or communication interface(s) 104 may communicate instructions, such as HTML, to the user interface to cause the user interface to display, compile, and/or render information content. In some examples, the content displayed by the user interface 112 may be interactive or responsive to user input. For example, the user interface 112 may communicate signals, messages, and/or information back to the communications interface 104 or system circuitry 106.

The system 100 may be implemented in many different ways. In some examples, the system 100 may be implemented with one or more logical components. For example, the logical components of the system 100 may be hardware or a combination of hardware and software. In some examples, each logic component may include an application specific integrated circuit (ASIC), a Field Programmable Gate Array (FPGA), a digital logic circuit, an analog circuit, a combination of discrete circuits, gates, or any other type of hardware or combination thereof. Alternatively or in addition, each component may include memory hardware, such as a portion of the memory 110, for example, that comprises instructions executable with the processor 102 or other processor to implement one or more of the features of the logical components. When any one of the logical components includes the portion of the memory that comprises instructions executable with the processor 102, the component may or may not include the processor 102. In some examples, each logical component may just be the portion of the memory 110 or other physical memory that comprises instructions executable with the processor 102, or other processor(s), to implement the features of the corresponding component without the component including any other hardware. Because each component includes at least some hardware even when the included hardware comprises software, each component may be interchangeably referred to as a hardware component.

Some features are shown stored in a computer readable storage medium (for example, as logic implemented as computer executable instructions or as data structures in memory). All or part of the system 100 and its logic and data structures may be stored on, distributed across, or read from one or more types of computer readable storage media. Examples of the computer readable storage medium may include a hard disk, a flash drive, a cache, volatile memory, non-volatile memory, RAM, flash memory, or any other type of computer readable storage medium or storage media. The computer readable storage medium may include any type of non-transitory computer readable medium, such as a CD-ROM, a volatile memory, a non-volatile memory, ROM, RAM, or any other suitable storage device.

The processing capability of the system 100 may be distributed among multiple entities, such as among multiple processors and memories, optionally including multiple distributed processing systems. Parameters, databases, and other data structures may be separately stored and managed, may be incorporated into a single memory or database, may be logically and physically organized in many different ways, and may implemented with different types of data structures such as linked lists, hash tables, or implicit storage mechanisms. Logic, such as programs or circuitry, may be combined or split among multiple programs, distributed across several memories and processors, and may be implemented in a library, such as a shared library (for example, a dynamic link library (DLL).

All of the discussion, regardless of the particular implementation described, is illustrative in nature, rather than limiting. For example, although selected aspects, features, or components of the implementations are depicted as being stored in memory(s), all or part of the system or systems may be stored on, distributed across, or read from other computer readable storage media, for example, secondary storage devices such as hard disks and flash memory drives. Moreover, the various logical units, circuitry and screen display functionality is but one example of such functionality and any other configurations encompassing similar functionality are possible.

The respective logic, software or instructions for implementing the processes, methods and/or techniques discussed above may be provided on computer readable storage media. The functions, acts or tasks illustrated in the figures or described herein may be executed in response to one or more sets of logic or instructions stored in or on computer readable media. The functions, acts or tasks are independent of the particular type of instructions set, storage media, processor 102 or processing strategy and may be performed by software, hardware, integrated circuits, firmware, micro code and the like, operating alone or in combination. Likewise, processing strategies may include multiprocessing, multitasking, parallel processing and the like. In one example, the instructions are stored on a removable media device for reading by local or remote systems. In other examples, the logic or instructions are stored in a remote location for transfer through a computer network or over telephone lines. In yet other examples, the logic or instructions are stored within a given computer and/or central processing unit (“CPU”).

Furthermore, although specific components are described above, methods, systems, and articles of manufacture described herein may include additional, fewer, or different components. For example, a processor 102 may be implemented as a microprocessor, microcontroller, application specific integrated circuit (ASIC), discrete logic, or a combination of other type of circuits or logic. Similarly, memories may be DRAM, SRAM, Flash or any other type of memory. Flags, data, databases, tables, entities, and other data structures may be separately stored and managed, may be incorporated into a single memory or database, may be distributed, or may be logically and physically organized in many different ways. The components may operate independently or be part of a same apparatus executing a same program or different programs. The components may be resident on separate hardware, such as separate removable circuit boards, or share common hardware, such as a same memory and processor for implementing instructions from the memory. Programs may be parts of a single program, separate programs, or distributed across several memories and processors.

In certain circumstances, the processor 102 may execute steps to search the metrics of the tree based on a query. In other words, the processor 102 may be configured to accept and process a request from a user. The request may include providing categories, limits, and/or filters for the user to analyze a selected forest more efficiently. For instance, the user may submit a request and/or a search query to the input interface 108 to analyze “all trees” within a predetermined area. In a specific non-limiting example, the user may classify the results of the processor 102 with requests and/or search queries such as “trees having a diameter greater than twenty-four inches.” The results of the processor 102 may then be plotted on the user interface 112. The user interface 112 may be configured to include a map of the forest shown from the point cloud data. The processor 102 may be configured to provide statistics about the features of trees found in the area of interest and display those statistics on the user interface 112. One skilled in the art may select other suitable types of requests and/or search queries for classifying, searching, and/or filtering the descriptors of the trees, within the scope of the present disclosure.

In certain circumstances, the present disclosure may specifically utilize a graph-based methodology to segment individual trees from high-resolution data. Given a graph-space encoding of a forest point cloud and a properly crafted cost function, the route of least cost from any given point in the forest canopy to the ground will pass through the trunk of the tree to which the canopy point belongs. The present disclosure includes a series of point cloud preprocessing steps followed by the graph building and pathfinding segmentation procedure. The series of point cloud preprocessing steps may be executed by the processor 102. The series of point cloud preprocessing steps may be divided into six processing steps: (1) Point Cloud Normalization, where the terrain elevation is subtracted from each point in the point cloud to remove the effect of the terrain; (2) Superpoint Encoding, where superpoints are created by aggregating the properties of all points within voxel cells into a single superpoint; (3) Rough Classification, where the height of a superpoint above the ground is used to identify ground points and canopy points; (4) Network Construction, where the cloud of superpoints is converted into a graph space by using superpoints as nodes and defining edge connections between nodes; (5) Least-cost Routing, in which the least-cost route from each canopy superpoint down to the first ground superpoint is traced, and branching network structures are built by linking all routes which end at the same ground superpoint; and finally (6) Final Segmentation, where neighboring branching structures are combined into tree-like networks, and each tree-like network is assigned a label that is recursively applied to all superpoints connected by the tree-like network and then to all original points encoded by each superpoint.

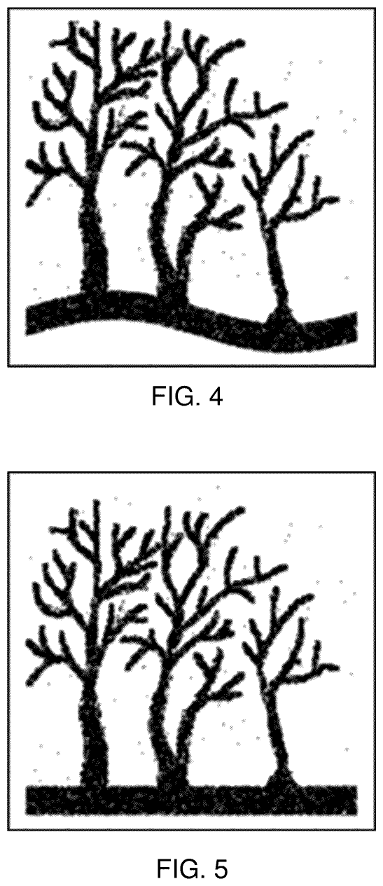

Before processing, the point cloud input data must be normalized to remove the effect of the terrain. Along with the point cloud, the user of the algorithm in the present disclosure may provide a digital terrain model (DTM) which encodes the elevation of the terrain in a regular grid pattern. For each point in the input point cloud, the three horizontally closest grids in the DTM are selected. These three points form a triangular, planar patch from which the distance-weighted average of the DTM grids is calculated. It should be appreciated any number points or shapes may be utilized, within the scope of the present disclosure. This interpolated ground elevation value may be subtracted from the elevation of the point to produce the normalized point cloud. The before and after effect of normalization is shown in FIGS. 4-5, respectively.

In certain circumstances, the present disclosure may include utilizing superpoints. Superpoints are points that summarize the properties of a small portion of the normalized point cloud. Implementing superpoint encoding may reduce the number of points within the input data, which increases processing speed, and reduces sensitivity to point density variations in the input data.

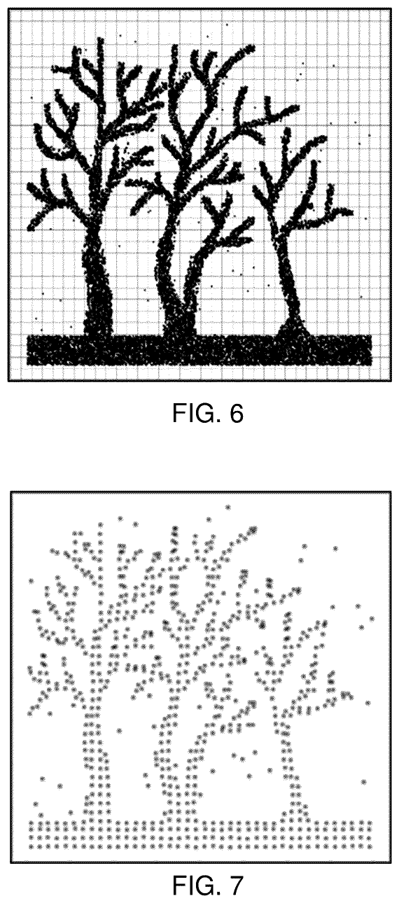

The region of the point cloud summarized by each superpoint is determined by voxelization. Voxelization was chosen for its ease of calculation. For each voxel in the normalized point cloud space, a single superpoint is calculated by averaging the horizontal coordinates and height values of all points falling within the voxel. FIG. 6 shows the normalized point cloud divided into voxel regions, while FIG. 7 demonstrates the results of the superpoint encoding step.

To reduce noise in the resulting superpoint cloud, a point count threshold b is applied. Voxels containing fewer than b points are ignored, and no superpoint is created to summarize these voxels. The choice of voxel size is a user input which should be approximately ½ the average diameter of the trees expected in the point cloud. In this paper, a voxel size was set to s=0.3 m for all datasets. Likewise, the threshold value for b should be provided by the user based on knowledge of the point cloud density and noise level. In this study, a point count threshold of b=10 was chosen for all datasets.

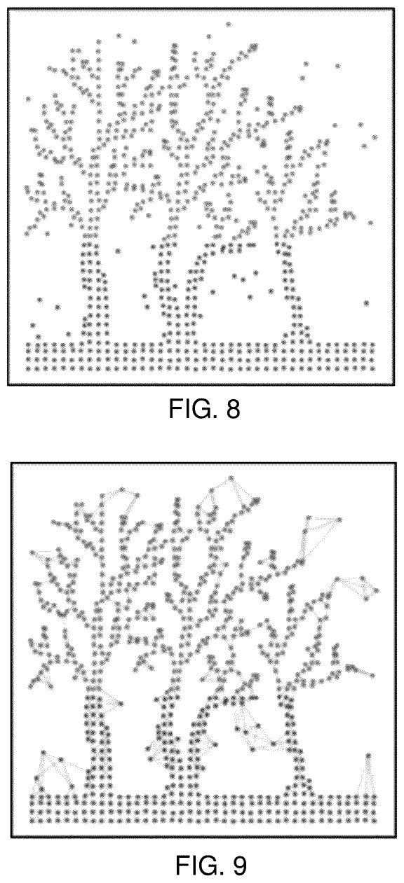

After converting the point cloud into superpoints, the next step classifies the superpoints into three categories—ground, canopy, and unlabeled. The height hᵢ of a superpoint above the ground surface determines its class according to the following thresholds:

$${p}_{i} ∈ \{ \begin{matrix}G & if {h}_{i} \leq {g}_{max} \\ C & if {h}_{i} \geq {c}_{min}\end{matrix} \qquad ( 1 )$$

where P is the set of all superpoints, pᵢ∈P, is the i^{th} superpoint, G⊆P is the subset of superpoints that are labeled as ‘ground’, C⊆P is the subset of superpoints that are labeled as ‘canopy’, h is the height of a superpoint above the ground, and gₘₐₓ and cₘᵢₙ are threshold parameters. The effect of rough classification is visualized in FIG. 8.

Advantageously, the present disclosure may include a canopy-to-root approach to find the location of individual trees. Canopy superpoints C serve as starting points, while ground superpoints G serve as destination points for the least-cost pathing routine. For this reason, cₘᵢₙ should be large enough to avoid classifying grass or other ground clutter as ‘canopy’ but small enough to include the canopy of trees of interest. Trees shorter than cₘᵢₙ are not detected by the algorithm of the present disclosure.

Before segmentation, a network is constructed in the superpoint space. A graph N=(P,E,W) consisting of nodes P, edges E, and weighs W, is constructed using the superpoints P as nodes.

Since the set P⊥ [symbol] ^{x,y,h} does not inherently define adjacency, a k-nearest neighbors (KNN) method was utilized, where k=10. After implementing KNN over all the superpoints P, an additional routine may be run to provide a symmetric graph. The connections defined between superpoints by the network construction step are shown in FIG. 9.

The costs of travel along the edges E are defined by the cost function W: E→ [symbol] which maps any edge eᵢⱼ∈E to a single cost value calculated as:

$$W ( {e}_{ij} ) = {‖ {p}_{i} - {p}_{j} ‖}^{2} \qquad ( 2 )$$

the square of the Euclidean distance between two adjacent superpoints. Advantageously, squaring the L2 norm encourages the least-cost routing routine to choose routes with smaller gaps between nodes and discourages the selection of longer, more direct routes. This may cause routes to follow the structure of the tree since near points are more likely to belong to the same branch than far points. Had the simple L2 norm been used, results may have become heavily influenced by the choice of k.

Both major tasks addressed by the algorithm of the present disclosure—locating the trunk positions of each tree and labeling each superpoint by the trunk to which it belongs—are accomplished in one graph operation. Given the graph definition above, the working assumption of the algorithm of the present disclosure is: for a given canopy superpoint cᵢ∈C, the route Rᵢ through graph N will link cᵢ to the base of the correct tree while only passing through superpoint nodes belonging to the same tree when the route Rᵢ is the least-cost route from cᵢ to any ground superpoint in G. In other words, when Rᵢ minimizes the function

$$\sum W ( {e}_{i , i + 1} ) \qquad ( 3 )$$

where eᵢⱼ is the edge connecting rᵢ to rⱼ, and the route Rᵢ has the following properties:
the route is a list of consecutively adjacent superpoints: Rᵢ={r₀, r₁, . . . , rₙ}, where ∀r∈P,
the first superpoint in the route is the selected canopy superpoint: r₀=cᵢ,
the last superpoint in the route is a ground superpoint: rₙ∈G,
the last superpoint in the route is the only ground superpoint: rᵢ∉G for 0≤i<n.

In the implementation, finding the routes R from all canopy superpoints C to the ground which satisfy the above conditions is accomplished using A* pathing. Desirably, A* pathing uses the position of the destination as a heuristic to direct the routing algorithm more quickly through the graph. However, in our application, finding the route from a given canopy superpoint to the ground, the destination superpoint is unknown. In fact, discovering the destination of this route, which would be the root of the tree, is a unique advantage of the algorithm of the present disclosure. To allow the use of A* pathing without knowing the destination point, a pseudo-destination qᵢ is created where qᵢ=[cᵢ_{ₓ} cᵢ_{_{y}} cᵢ_{ₕ}−100 m]^{T}. This definition of the destination provides a heuristic that encourages downward routing.

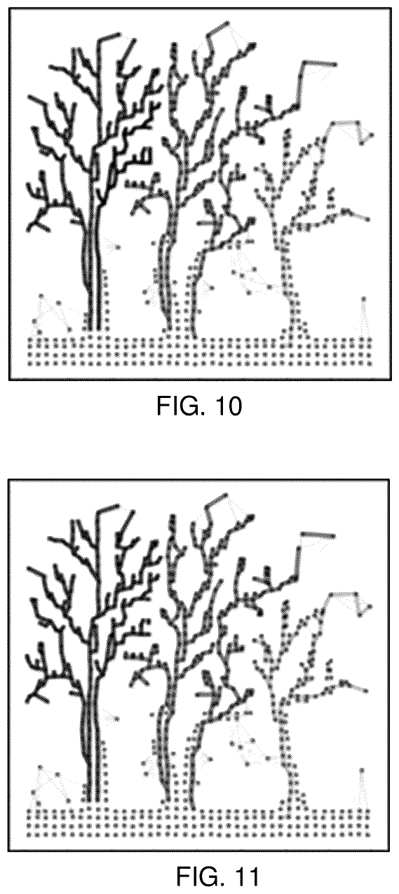

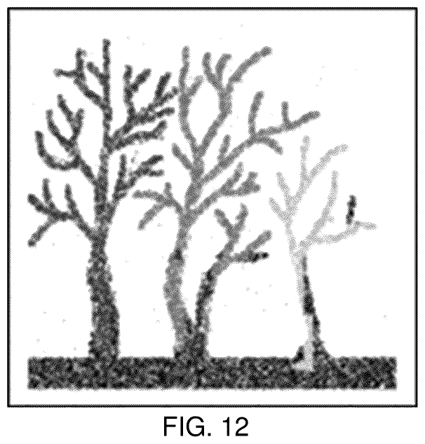

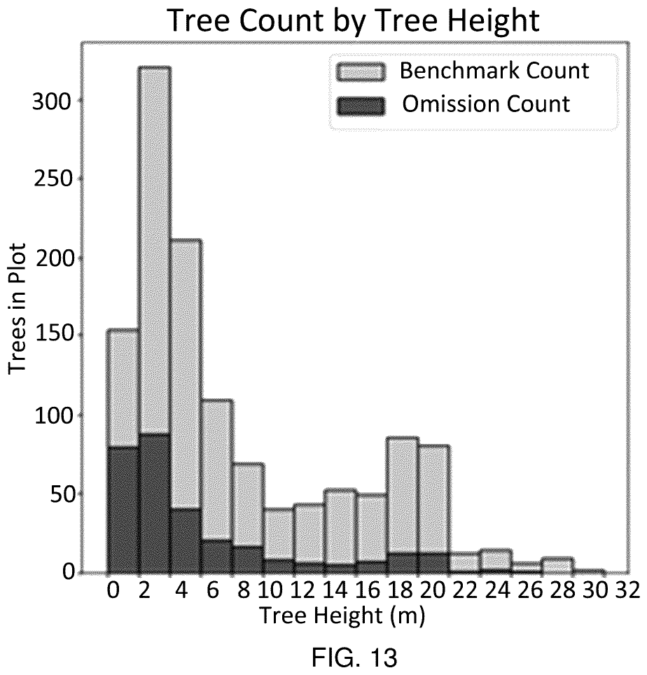

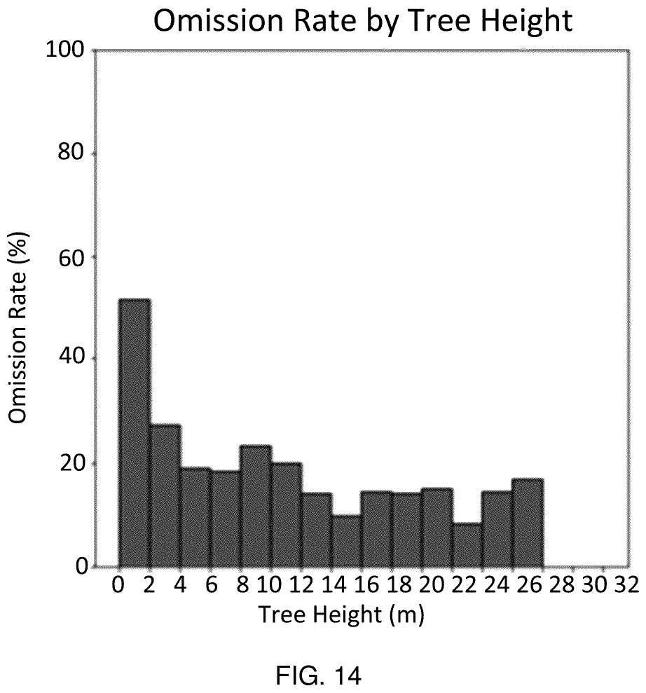

The use of a pseudo-destination raises another problem. Since qᵢ∉P is not part of the network, no route exists from the canopy superpoint cᵢ to the pseudo-destination qᵢ. Thus, a stopping criterion, other than reaching the destination, must be introduced. The routing will cease if, while searching for a path to qᵢ, a ground superpoint is encountered; that is, if rₙ∈G. In this case, the algorithm recognizes the route Rᵢ as a new tree and adds all superpoints in the route ∀r∈Rᵢ to a new tree set Tᵢ. As shown in FIG. 10, routes may be linked together to form tree sets.

If the point cloud data includes large occlusions or regions of sparse point density, the graph N may contain areas isolated from the ground. In this environment, the least-cost pathing algorithm may not meet the stopping criteria detailed above. For this reason, a second stopping criterion may be included which monitors the number of nodes that can be accessed by the least-cost routing routine and ends the search when all accessible superpoints have been tested for a viable route. In this scenario, superpoints in the route Rᵢ are not added to any tree set Tⱼ and are not classified.

Depending on the order that each canopy point is visited, and the size of a given tree in the point cloud, a single tree in the point cloud may be described by multiple tree sets Tᵢ. To combat this artifact, a merging procedure is completed before final segmentation. The horizontal coordinates of the superpoint with the lowest elevation tₘᵢₙⁱ∈Tᵢ in each tree set Tᵢ⊆T are taken as the position of the tree set. If two tree sets, Tᵢ and Tⱼ, are within a threshold d of each other, the two three sets are merged; that is: Tᵢ∪Tⱼ if ∥tₘᵢₙⁱ−tₘᵢₙ^{j}∥<d. In this paper, the merge radius d=3 s=0.9 m, where s is the voxel size. Error! Reference source not found. illustrates how tree sets are grouped to form single trees.

Segmentation of the point cloud is completed by labeling all superpoints with a label corresponding to the tree path routing through it. Then, these superpoint labels may be assigned to the points constituting each superpoint. The algorithm may then return a point cloud with a classification value for all points. Points not included in any tree are given a classification of 0, as shown in Error! Reference source not found.

For stem mapping purposes, the horizontal coordinate of each tree may be required. The trunk location for each tree may be calculated by averaging the horizontal positions of all point cloud points belonging to that tree that are less than around one meter above the ground elevation. The resulting stem map may be utilized to validate the segmentation method of the present disclosure.

### EXAMPLE

Multiple point cloud datasets were utilized to validate the results of the forestry management system 100. These point cloud datasets were captured using three distinct technologies—TLS, UAV-based photogrammetry, and UAV-based LiDAR. Each dataset was accompanied by a manually created tree map which encodes the height and position of every tree in the dataset. This tree map was used to validate the results of tree stem mapping and segmentation.

The TLS datasets were acquired from the International TLS Benchmarking project, organized by the Finnish Geospatial Research Institute. Each of the six publicly available datasets captures a separate 32 m×32 m forest plot in the southern boreal forest of Evo, Finland. The dominant tree species in the plots are Scots pine, Norway spruce, silver birch, and downy birch. Researchers from the University of Helsinki, Finland, collected the data during April and May of 2014. Each plot was covered with five stationary scans using a Leica HDS6100 terrestrial laser scanner. These were combined into a multi-scan point cloud in post-processing. Each dataset is accompanied by a digital terrain model (DTM) extracted from the multi-scan point cloud and a tree map that includes positions, heights, and diameters at breast height (DBH) of all trees in the plot whose DBHs are greater than 5 cm. Tree positions were manually measured by the researchers from the multi-scan point cloud and represent the center of the trunk at breast height; heights were measured with an inclinometer to a resolution of 10 cm; and DBHs were measured with steel calipers. Two plots are categorized as easy to segment, two as intermediate to segment, and the remaining two as difficult to segment. These categories were designated intuitively based on stem visibility at ground level, stem density, and variation of DBH.

A limitation of this dataset is that tree features are only provided for trees whose DBHs exceeded 5 cm. It is apparent, by visual inspection, that many trees exist in the scanned plots whose DBHs are less than 5 cm. Thus, to avoid the validation errors which small vegetation, steps must be taken to exclude small trees from the segmentation results so that the results match the limitations of the validation data sets. However, filtering segmentation results by DBH requires an additional procedure to be developed for automatically detecting the DBH of segmented trees. Segmentation validation results are then greatly affected by the accuracy of a secondary filtering step. Instead of introducing error by attempting to filter segmentation results, the point clouds were used to manually measure the tree positions and heights of all trees in the six plots which originally had been excluded from the provided validation data.

To acquire UAV LiDAR datasets, TLS point clouds were collected from stationary or mobile devices produce highly detailed models of a forest environment. However, these methods are limited in spatial coverage. Aerial LiDAR mounted to UAV platforms can cover large, forested areas quickly. While aerial LiDAR is the preferred data collection technique for forest mapping because of its ability to penetrate the canopy, details of the stem structure are still highly limited when leaves are present. To complete accurate stem mapping with LiDAR data, a validation data set was created using aerial LiDAR collected during the leaf off-season.

A MATRICE™ 300 platform was mounted with a ZENMUSE® L1 lidar sensor for aerial lidar acquisition. The flight mission was conducted over a 58 m×58 m portion of the 4D compartment of Martell Forest, a research forest in northern Indiana, USA (40.44105, −87.03353). This compartment is a natural forest area comprised mostly of oak and hickory species. The flight parameters of the UAV LiDAR mission are presented in Table 2.

TABLE 2
The flight parameters of the UAV LiDAR mission.

| | LiDAR-Natural |
|---|---|
| Altitude | 100 m |
| Lidar Pulse Rate | 240 kHz |
| Flying Speed | 6 m/s |
| Sidelap | 80% |

The ZENMUSE® L1 sensor comprised a LIVOX® Avia LiDAR sensor and BOSCH® BMI088 inertial measurement unit housed and mounted on a 3-axis gimbal. The sensor was integrated with the MATRICE™ 300's onboard RTK system. The trajectory and final point cloud are computed using the DJI TERRA® software. The RTK system has a horizontal accuracy of around ten centimeters and a vertical accuracy of around five centimeters at fifty meters altitude. The resulting point cloud of the 4D site contains 2.2 million points with an approximate horizontal point density of about 670 points/m². This dataset may be defined as LiDAR-Natural.

To validate segmentation results, a tree map was built of the plantation site. Tree positions and heights were manually measured from the LiDAR point cloud.

To obtain UAV photogrammetric data, a MATRICE™ 300 platform was mounted with a ZENMUSE® P1 RGB camera for image acquisition. Two flight missions were conducted. The first was flown over a 65 m×130 m well-maintained plantation of mature walnut trees in Martell Forest. This dataset may be defined as Photo-Plantation. The second was flown over a 58 m×58 m portion of the 4D compartment of Martell Forest. This compartment is a natural forest, with oaks and hickories being the dominant species. This dataset may be defined as Photo-Natural. The flight parameters of these two flights are presented in Table 3.

TABLE 3
The flight parameters of the UAV Photogrammetry missions.

| | Photo-Plantation | Photo-Natural |
|---|---|---|
| Altitude | 80 m | 110 m |
| Ground Sampling Distance | 1 cm | 1.4 cm |
| Overlap | 90% | 90% |
| Sidelap | 90% | 80% |

We utilized the INCORS INWL base station maintained by the Indiana Department of Transportation and the MATRICE™'s RTK capabilities to do direct georeferencing on the images. Five ground control points (GCPs) were also deployed to check for any horizontal shift in the absolute coordinates of the data. The GCPs were surveyed with a Trimble R10 survey grade GNSS receiver also utilizing the INCORS INWL base station for RTK positioning.

The images were processed using the photogrammetric processing software Agisoft METASHAPER. The four-step processing procedure available from METASHAPER was followed. The four-step processing procedure includes: align photos, build dense point cloud, build DEM, and build orthomosaic. The ‘high accuracy’ option was used to align photos. ‘Mild depth filtering’ was implemented by METASHAPER while building the dense point cloud. The DEM and orthomosaic were created, and the orthomosaic was used to extract the GCP coordinates as computed in the photogrammetric reconstruction. These coordinates were then compared to the surveyed coordinates of the GCPs to calculate horizontal and vertical shift errors. The absolute shift error was found to be Δx=3 cm, Δy=7 cm, Δz=5 cm. The dense point cloud was then exported in the LAS format, and a correction for the shift error was applied using an in-house developed python script. The resulting photogrammetric point cloud contains 13.4 million points with an approximate horizontal point density of 16 k points/m².

To validate segmentation results, a tree map was built for both photogrammetric test sites. Tree positions and heights were manually measured from the photogram-metric point clouds.

A state-of-the-art algorithm (SOTA) was used on the datasets described above. In certain circumstances, the code used to implement the SOTA algorithm may require certain parameters to be defined by a user. For instance, provided as a non-limiting example, Error! Reference source not found. illustrates the values of the parameters used when implementing the SOTA algorithm. The ‘Height’ and ‘Verticality’ parameters were varied between datasets to achieve better results.

TABLE 4
Parameter values used in the SOTA implementation.

| Parameter | Value |
|---|---|
| Threshold | 0.125 |
| Height | Ranged from 2-10 |
| NoP | 100 |
| Verticality | Ranged from 0.6-0.8 |
| Length | 2 |
| Merge Range | 0.3 |

In validating the results of the segmentation and stem mapping method presented above, a primary point of concern is whether a given reference tree has been detected. As previously discussed, each test point cloud may be accompanied by a manually built stem map that contains the position and height of each tree in the reference dataset. In a specific example, an automated method may be employed to make a one-to-one match between each segmented tree location and the corresponding reference tree locations. For instance, the automation may match a location and/or a position of a segmented tree across a plurality of datasets and/or maps. Advantageously, this automated matching procedure may significantly enhance the efficiency and accuracy of the method.

To match segmented tree positions to reference tree positions, an algorithm was utilized to match elements of two equal-length sets into ‘stable’ pairs. A pair is considered ‘stable’ when there is no unmatched pair where both members are more similar to each other than to their current matches. Our modification allows the sets of segmented tree positions T and reference tree positions V to differ in length. The similarity rank between segmented and reference trees is calculated as:

$${θ}_{ij} = \frac{{d}_{ij}}{r} \times \frac{\vert {h}_{i} - {h}_{j} \vert}{{h}_{i}} \qquad ( 4 )$$

where θᵢⱼ is the similarity rank of segmented tree ti with reference tree vⱼ, dᵢⱼ is the Euclidian distance between segmented tree tᵢ and reference tree vⱼ, r is a radius about tᵢ in which a possible match is valid (for instance, around two meters), and h is the height of the tree. For both segmented and reference trees, the height is defined as the maximum height above the ground of all points belonging to the respective tree. For segmented trees, this height was automatically extracted; and for reference trees, this height was measured manually. Note that the smaller the value of θᵢⱼ, the more similar the two trees are to each other. This similarity rank matches trees based on their horizontal closeness and their similarity in height.

Following the precedent set by the International TLS benchmarking project, the segmentation accuracy was assessed for a given method using the metrics of completeness, correctness, and mean accuracy given by

$$Completeness = \frac{{n}_{M}}{{n}_{V}} \qquad ( 5 )$$

$$Correctness = \frac{{n}_{M}}{{n}_{T}} \qquad ( 6 )$$

$$IoU = \frac{{n}_{M}}{{n}_{V} + {n}_{T} - {n}_{M}} \qquad ( 7 )$$

where n_{M} is the number of matched segmented and reference tree pairs, n_{V} is the number of reference trees, and n_{T} is the number of segmented trees. As an alternative to mean accuracy, the Intersection over Union (IoU) metric was utilized.

We evaluate the stem mapping performance of our algorithm on six benchmark point cloud datasets collected with terrestrial laser scanners (TLS1-6), two-point cloud datasets collected with Photogrammetric systems, and one point cloud dataset captured by UAV mounted LiDAR (LiDAR-Natural). The matching procedure described above may be implemented to pair the positions of segmented trees to the positions of trees in the reference data. After the pairing procedure, the number of reference trees, segmented trees, and matched pairs are tallied. These tallies may be used to calculate the evaluation metrics described above. Error! Reference source not found. lists the validation results for the TLS datasets and reports the evaluation metrics achieved by both the algorithm of the present disclosure and a known methodology (SOTA). Error! Reference source not found. lists the validation results for the Photogrammetric and LiDAR datasets along with the evaluation metrics.

TABLE 5
Tabulated segmentation results achieved by our UCRP algorithm, and comparison of our
algorithm and the SOTA algorithm on the International TLS Benchmarking Datasets.

| | Reference | Segmented | Matched | | | Completeness % | | Correctness % | | IoU % | |
|---|---|---|---|---|---|---|---|---|---|---|---|
| Dataset | Trees | Trees | Trees | Omissions | Commissions | Ours | SOTA | Ours | SOTA | Ours | SOTA |
| TLS1 - Easy | 152 | 139 | 121 | 31 | 18 | 79 | 38 | 87 | 93 | 71 | 37 |
| TLS2 - Easy | 172 | 137 | 133 | 39 | 4 | 77 | 38 | 97 | 94 | 75 | 37 |
| TLS3 - Intermediate | 275 | 256 | 211 | 64 | 45 | 76 | 50 | 82 | 93 | 65 | 48 |
| TLS4 - Intermediate | 121 | 168 | 106 | 15 | 62 | 87 | 23 | 63 | 76 | 57 | 22 |
| TLS5 - Difficult | 242 | 256 | 187 | 55 | 69 | 77 | 55 | 73 | 83 | 60 | 50 |
| TLS6 - Difficult | 292 | 256 | 200 | 92 | 56 | 68 | 1 | 75 | 80 | 57 | 1 |
| Totals | 1254 | 1212 | 958 | 296 | 254 | 76 | 37 | 79 | 90 | 64 | 36 |

Bold indicates the best performer.

TABLE 6
Tabulated segmentation results achieved by our UCRP algorithm, and comparison
of our algorithm the SOTA algorithm on Photogrammetry and LiDAR Datasets.

| | Reference | Segmented | Matched | | | Completeness % | | Correctness % | | IoU % | |
|---|---|---|---|---|---|---|---|---|---|---|---|
| Dataset | Trees | Trees | Trees | Omissions | Commissions | Ours | SOTA | Ours | SOTA | Ours | SOTA |
| Photo - Plant. | 133 | 129 | 129 | 4 | 0 | 96 | 54 | 100 | 96 | 96 | 52 |
| Photo - Natural | 51 | 54 | 44 | 7 | 10 | 86 | 25 | 81 | 84 | 72 | 24 |
| LiDAR - Natural | 71 | 49 | 42 | 29 | 7 | 59 | 15 | 85 | 83 | 53 | 15 |

Bold indicates the best performer.

Examples of the segmentation results for each of the three difficulty levels present in the International TLS Benchmark dataset. As seen in Error! Reference source not found., on this dataset provided as a non-limiting example, the algorithm of the present disclosure achieves a combined completeness score of 76%, correctness score of 79% and IoU of 64%. The algorithm of the present disclosure outperforms the SOTA algorithm in completeness and IoU scores. The SOTA algorithm achieves a higher combined correctness score indicating that segmented trees are more likely to be matched with a validation tree in the SOTA implementation. However, the SOTA algorithm only achieves a combined completeness score of 37%, indicating a high number of omissions. Taken together, these two metrics indicate that the SOTA implementation was only able to segment a few trees but found matches for most of the few trees it segmented.

It should be appreciated that completeness is a more critical measure of performance than correctness. For instance, a low correctness value implies a high rate of commission errors (false positives). While a low completeness value implies a high rate of omissions (false negatives). While not desirable, commissions can be filtered out as a post-processing step if necessary. However, omissions cannot be recovered.

Reviewing the results from each International TLS Benchmark plot separately shows that the algorithm of the present disclosure performs better than the SOTA algorithm in both completeness and IoU metrics regardless of scene complexity. Additionally, a decrease in performance is observed in the algorithm of the present disclosure as scene complexity increases. This is a trend found in nearly all tree segmentation methods, including the SOTA algorithm. The performance of the algorithm of the present disclosure, however, decreases much less rapidly, significantly outperforming the SOTA in complex scenes. This may be attributed to the algorithm of the present disclosure, unlike the SOTA, not relying on the identification of trunk locations before segmentation. In complex scenes, the trunk is often hidden by brush or neighboring trees making it difficult for trunks to be detected directly. Advantageously, the algorithm of the present disclosure avoids this source of error by finding trunks at the end of the segmentation process instead of making it a prerequisite.

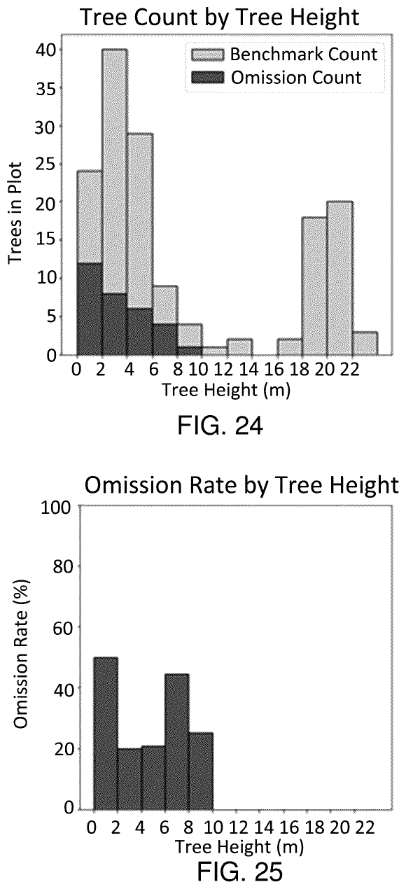

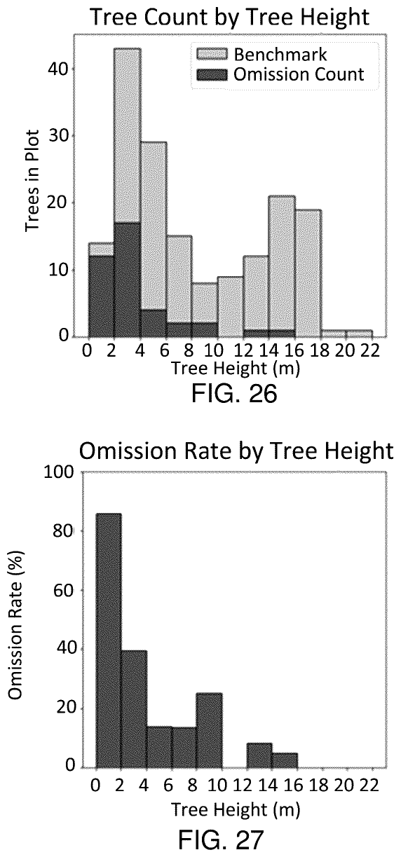

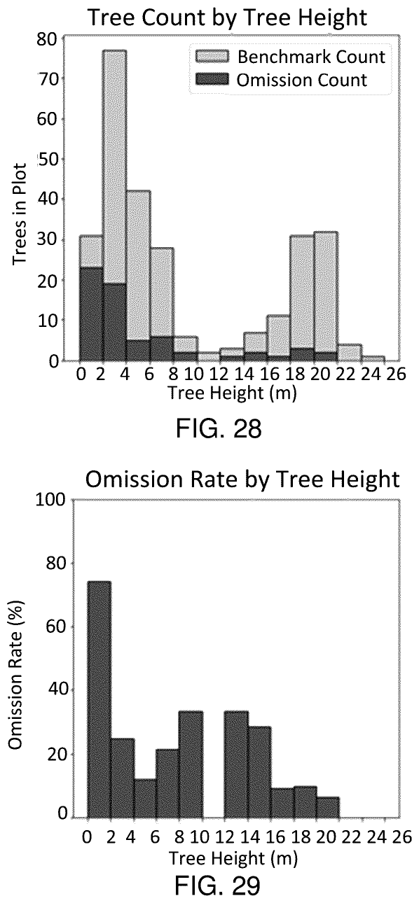

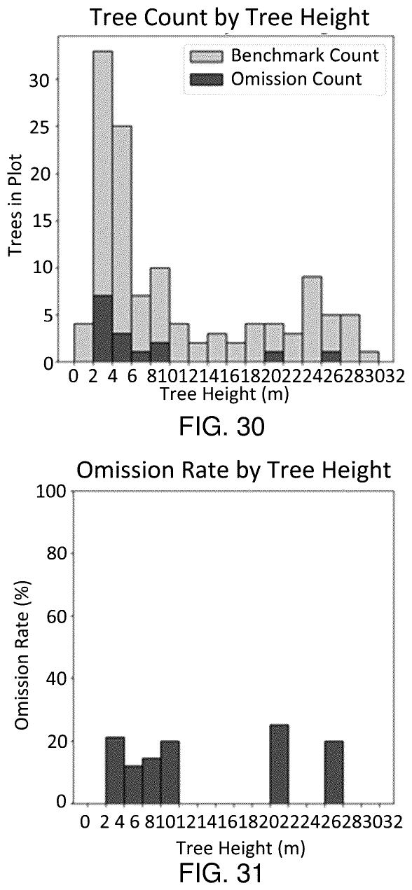

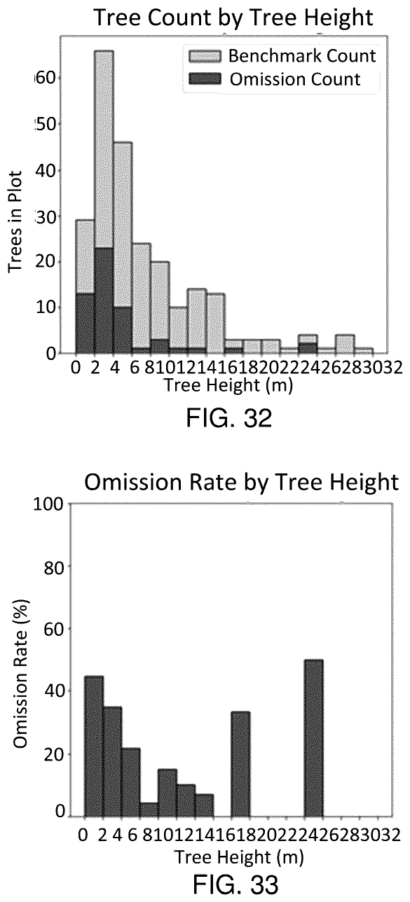

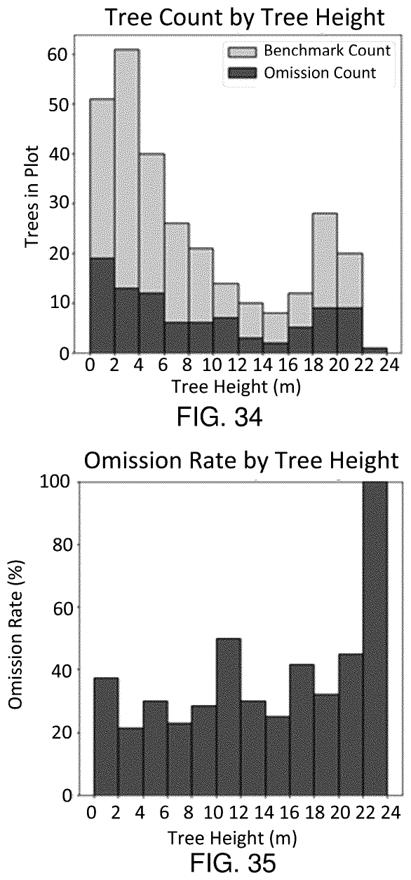

In certain circumstance, one significant difference between the present disclosure and other known studies which have used the International TLS Benchmarking dataset is the validation data used. Known studies have only validated segmentation results on trees greater than five centimeters in diameter. The present disclosure digitized the positions and heights of all trees in the TLS datasets. This complete validation dataset allows omission errors to be analyzed by tree height. Error! Reference source not found.—14 illustrate the combined errors of omission from six TLS datasets subdivided by validation tree height. While trees less than four meters are omitted at a rate of 30%-50%, taller trees have a lower omission rate of 15%-20%. FIGS. 24-35 illustrate the breakdown of omissions by tree height for each of the TLS datasets separately.

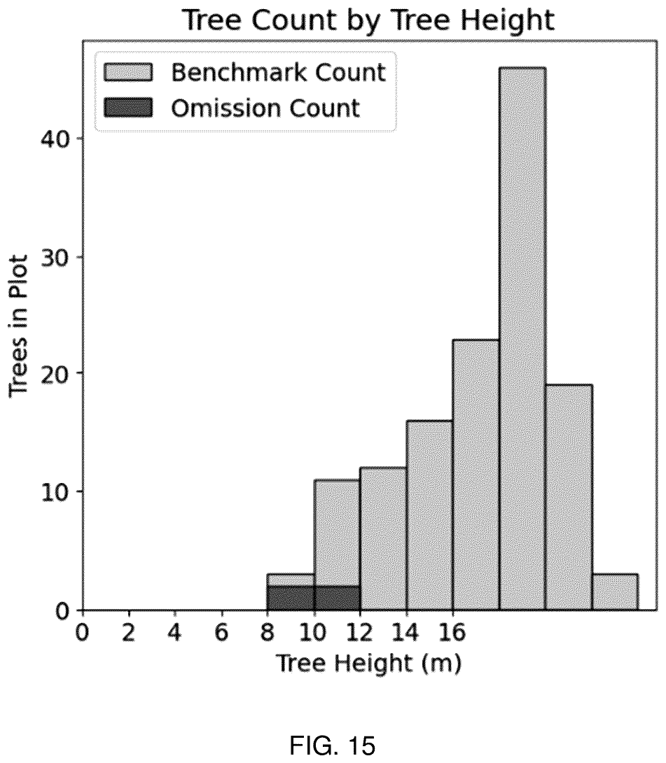

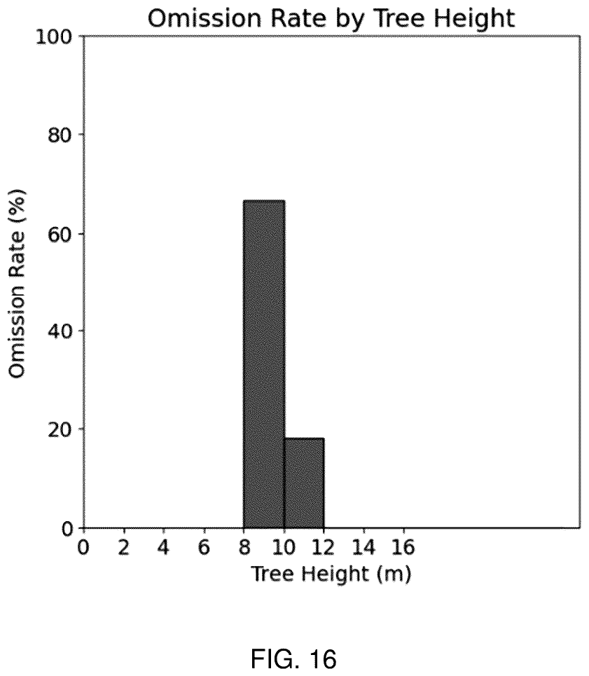

Two photogrammetric datasets were used for algorithm testing. Both were collected during leaf-off conditions. The first dataset, Photo-Plantation, was collected over a plantation of mature Walnut trees. This dataset is characterized by evenly spaced trees on a flat, mowed surface. This dataset achieved the best evaluation score (Error! Reference source not found.) with an IoU of 96%. The omission graphs illustrated in FIGS. 15-16 show that the omissions causing the 4% were of the smallest trees in the plot. Visual inspection of the point cloud reveals that these trees in the 4% were not captured by the input photogrammetrically constructed point cloud. The success of this plot may be attributed to the even spacing and well-maintained grounds present in the plot.

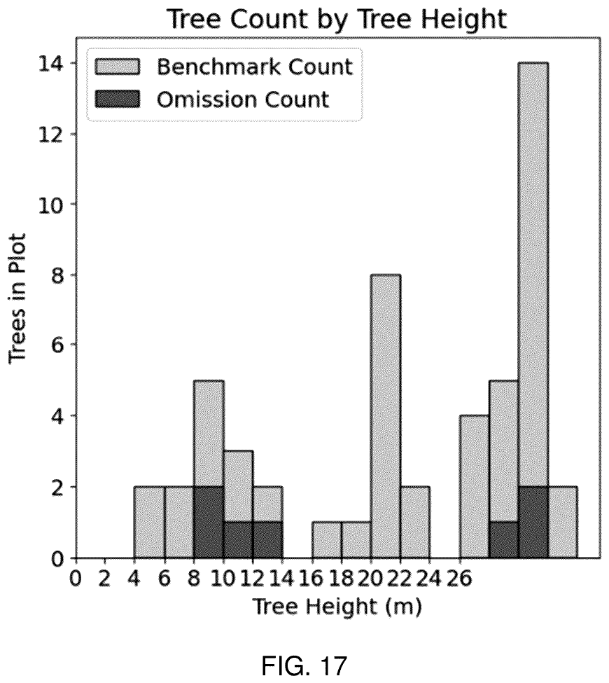

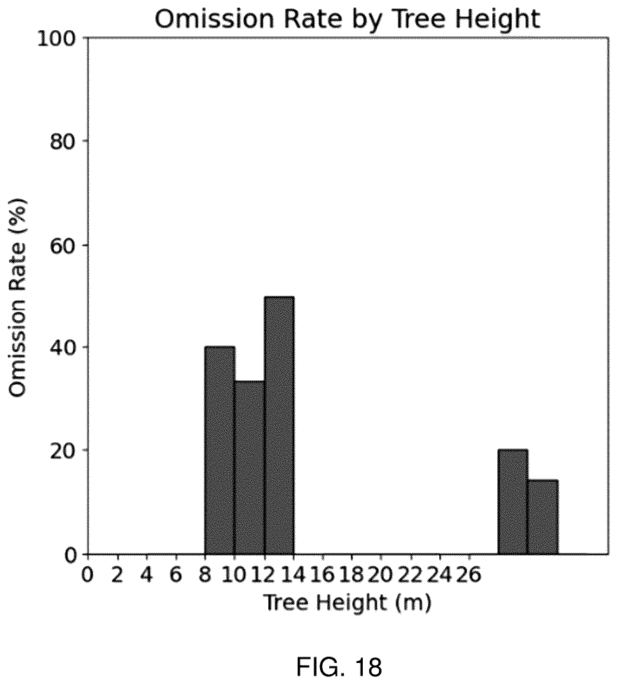

The second photogrammetric dataset, Photo-Natural, was captured over an area of natural forest. As shown in FIGS. 17-18, the algorithm of the present disclosure performed better on this photogrammetric point cloud than on the UAV-based LiDAR dataset of the same stand. This is because photogrammetric reconstruction relies on finding single features in separate images. The automatic tie point algorithms used by Metashape® rarely identify small features such as fine twigs or small branches in multiple images. This means that these features are not reconstructed. This artifact produces point clouds that contain none of the small vegetation noise common to both TLS datasets and UAV-based LiDAR. This demonstrates the advantage of using photogrammetry for tree stem mapping.

One UAV-based aerial LiDAR dataset was used for algorithm testing. LiDAR-Natural was collected over a naturally forested area with a lower quality LiDAR unit. This dataset is characterized by a higher level of noise than the photogrammetric point clouds. This is caused firstly by the lower point precision achievable using the Zenmuse® L1, and secondly, because LiDAR will produce returns on small branches and fine vegetation. The extra noise in the dataset causes lower accuracy in the tree segmentation routine. This can be seen in the IoU value achieved, 53% (Error! Reference source not found.).

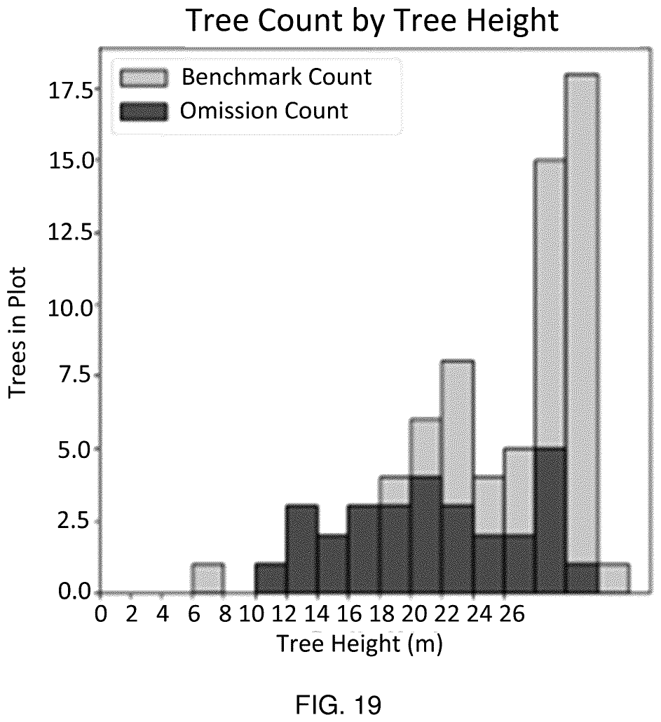

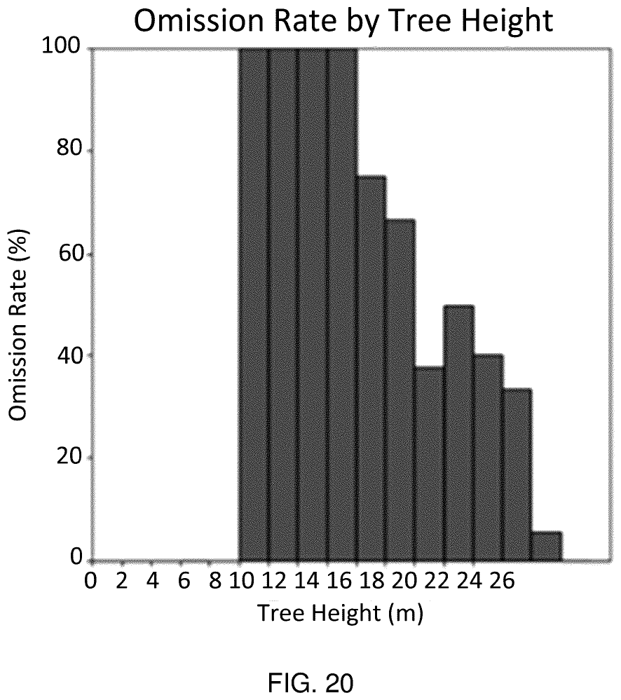

The omission analysis, as shown in FIGS. 19-20, indicates a much higher omission rate of small trees. This is likely due to the overall lower point density of the LiDAR dataset and the decreased point of the point cloud near the ground.

Segmentation errors may occur when an operating assumption—that the least-cost path from the canopy to the ground will route through the correct trunk—is invalid. There are three common cases when the assumption is invalid, and each causes a unique artifact in the segmentation results.

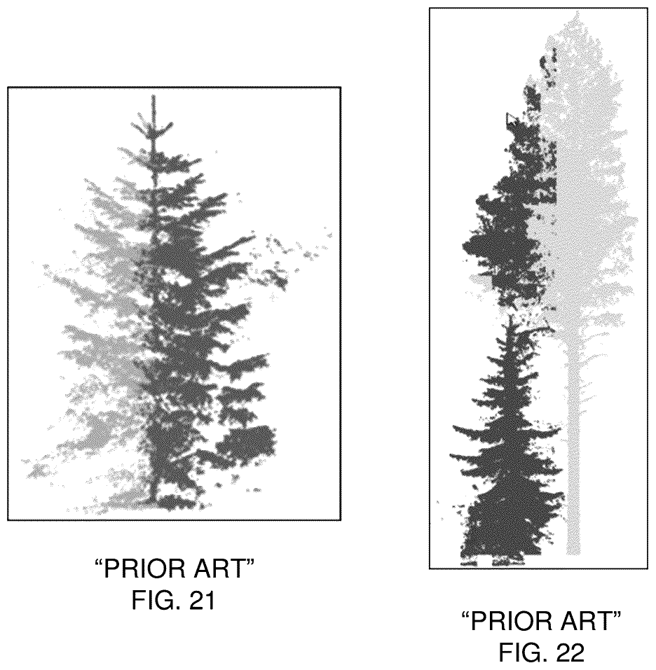

In case 1, a valid path from the canopy to the ground can be found through the branches, and not the trunk, of the tree. This causes the ‘split tree’ artifact as shown in FIG. 21. This is often the case with coniferous trees where the branches are present along the entire length of the trunk or when grass or small trees grow thickly around the trunk of a deciduous tree. This case causes errors of commission because a single tree may be segmented into multiple trees.

Case 2 may not result in omissions or commissions but will result in a miss-segmentation of the point cloud. Called the ‘greedy tree’, this error arises when some portion of a tree's canopy finds the lowest-cost path to the ground through a nearby tree. This error is especially prevalent in dense forests where several layers of the canopy are intertwined. An example is shown in FIG. 22.

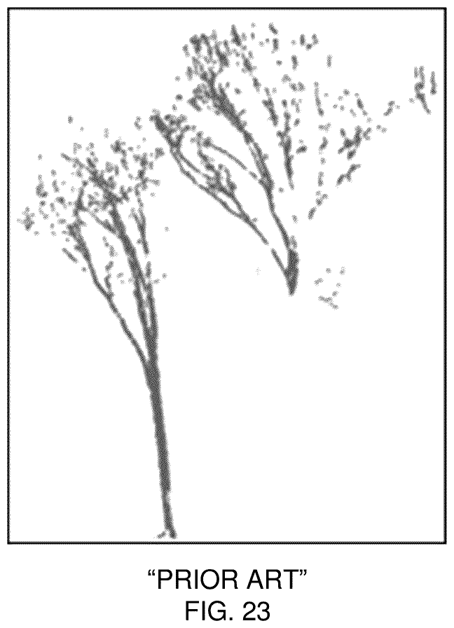

The ‘detached tree’ artifact occurs in case 3 because of data missing from the input point cloud, as illustrated in FIG. 23. There are several causes of this missing data. In TLS data, occlusions from objects nearer to the scanner can cause trunks to be shadowed. In photogrammetric data, trees of smaller diameter at breast height (DBH) are often missing from the point cloud after reconstruction. For any point cloud, errors from occlusions are much more prevalent in natural forests, as can be seen by the higher omission rates in the TLS, Photo-Natural, and LiDAR-Natural results when compared to the Photo-Plantation dataset. Missing data in the input dataset cannot be recreated by the algorithm of the present disclosure and may result in a missing or incorrectly segmented tree.

Known methods which have used least-cost routing to segment individual trees have used a root-to-canopy direction for the routing algorithm. This direction necessitates dividing the segmentation process into two separate steps; first, the base of individual trees must be identified, then least-cost routing can be used to attach the canopy points to individual roots. Conversely, the present disclosure simplifies this process into a single routing operation if the direction of routing is flipped. For instance, in a specific example, the proposed canopy-to-root method of the present disclosure may allow tree stem positions to be located and individual trees segmented without the need for a separate root-finding routine. Advantageously, the accuracy analysis shows that this simplification has not only matched published, state-of-the-art results, but has even exceeded state-of-the-art results on complex scenes.

As previously discussed, one drawback of the present disclosure is its tendency to split single trees into multiple trees when vegetation or low-hanging branches obscure the trunk structure. This is particularly evident on coniferous trees, which tend to have larger branches lower on the trunk. In this case, routes traveling down from the canopy tend to diverge near the ground. To improve this, it is contemplated to use a combination of canopy-to-root and root-to-canopy mapping to solve these problems. Canopy-to-root routing could find the trunks of deciduous trees, while a root-to-canopy direction could find coniferous trees.

Tree extraction and stem mapping is a critical first step in forest mapping and tree-scale feature extraction. The unsupervised canopy-to-root pathing (UCRP) routing of the present disclosure both segments the point cloud and discovers stem locations in a single routine. The method of the present disclosure was evaluated using six TLS benchmark datasets, two photogrammetric datasets collected during the leaf-off season, and one dataset collected from aerial LiDAR during the leaf-off season. Results show that the present disclosure achieved state-of-the-art performances in individual segmentation and stem mapping accuracy on the benchmark datasets. Additionally, the algorithm of the present disclosure achieves similar performance on point clouds from photogrammetric reconstruction and aerial LiDAR sensors.

It is contemplated that segmentation approach of the present disclosure may be added as an initial step in an automatic forest inventory pipeline. Since the algorithm of the present disclosure performs well on both LiDAR and photogrammetry data modalities, the present disclosure may support any type of large-area, high-resolution, UAV mapping system. This provides a significant advance to three-dimensional forest mapping and to the future of automatic forest inventory procedures.

Advantageously, the forestry management system 100 may provide an unsupervised method for segmenting individual trees from point clouds. The method 200 may use least-cost routing from tree canopy points down to the ground to simultaneously segment individual trees and find trunk locations. Desirably, this canopy-to-root routing direction may remove the need to perform a separate trunk-detection routine. Since point clouds can be derived from multiple procedures which each presenting unique omissions in the data, the algorithm of the present disclosure is applicable to datasets collected with terrestrial laser scanners (TLS), photogrammetrically derived point clouds, and LiDAR datasets collected from unmanned aerial vehicle (UAV) platforms. Further, the forestry management system 100 includes enhanced visualization of various forest types, such as boreal hardwood, temperate hardwood, natural forests, and plantations. Additionally, the tested forestry management system 100 exceeds the accuracy of the state-of-the-art forest segmentation methods.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions, and methods can be made within the scope of the present technology, with substantially similar results.

What is claimed is:

1. A forestry management system comprising:
a processor which executes steps to;
input point cloud data into the forestry management system,
segment the tree from the point cloud data using unsupervised, graph-based clustering,
identify a metric of a tree using an algorithm,
and
determine a trunk location of the tree.

2. The forestry management system of claim 1, wherein the metrics include at least one of a height of the tree, a biomass of the tree, a health status of the tree, and a species of the tree.

3. The forestry management system of claim 1, wherein the metric is a stem location and a position of the tree.

4. The forestry management system of claim 3, wherein the position of the tree is the angle of a trunk of the tree in relation to a ground surface.

5. The forestry management system of claim 1, wherein the algorithm has a canopy-to-root routing direction.

6. The forestry management system of claim 5, wherein the canopy-to-root routing direction simultaneously segments the point cloud data and discovers a stem location of the tree.

7. A method of using a forestry management system, the method comprising the steps of:
providing a forestry management system including a processor which executes steps to input point cloud data into the forestry management system, segment the tree from the point cloud data using unsupervised, graph-based clustering, identify a metric of a tree using an algorithm, and determine a trunk location of a tree;
preprocessing the point cloud data;
building a graph model;
identifying the canopy to root path of the tree;
segmenting the tree from remaining point cloud data; and
determining the trunk location of the tree.

8. The method of claim 7, wherein the step of preprocessing the point cloud data includes normalizing the point cloud data by subtracting a terrain elevation from each point in the point cloud data.

9. The method of claim 8, wherein the step of preprocessing the point cloud data includes identifying a plurality of voxel cells and aggregating each point within the corresponding voxel cells, thus forming a superpoint from each aggregation.

10. The method of claim 9, wherein the step of preprocessing the point cloud data includes applying a point count threshold by ignoring voxels containing fewer than a predetermined number of points.

11. The method of claim 9, wherein a ground point and a canopy point are identified from a height of the superpoints.

12. The method of claim 11, wherein the ground point and the canopy point are calculated from the algorithm as:
$${p}_{i} ∈ \{ \begin{matrix}G & if {h}_{i} \leq {g}_{max} \\ C & if {h}_{i} \geq {c}_{min}\end{matrix}$$

13. The method of claim 11, wherein the graph model is built by defining an edge between at least two superpoints.

14. The method of claim 13, wherein the graph model is calculated from the algorithm as:
N=(P,E,W)

15. The method of claim 13, wherein the step of identifying the canopy to root path of the tree further includes identifying a cost value of the edge to the ground point.

16. The method of claim 15, wherein the cost value is calculated from the algorithm as:
$$W ( {e}_{ij} ) = {‖ {p}_{i} - {p}_{j} ‖}^{2}$$

17. The method of claim 15, wherein the step of identifying the canopy to root path of the tree further includes identifying a least-cost route of superpoints between the canopy point and the ground point.

18. The method of claim 7, wherein the step of identifying the canopy to root path of the tree and the step of segmenting the tree from remaining point cloud data occur simultaneously.

19. The method of claim 7, wherein the step of segmenting the tree from remaining point cloud data precedes the step of determining the trunk location of the tree.

20. The method of claim 7, wherein the step of segmenting the tree from remaining point cloud data and the step of determining the trunk location of the tree occur simultaneously.
